(19) United States
(12) Patent Application Publication
(10) Pub. No.: US 2025/0200304 A1
(43) Pub. Date: Jun. 19, 2025

(54) INFORMATION PROCESSING DEVICE, INFORMATION PROCESSING METHOD, AND RECORDING MEDIUM

(71) Applicant: NEC Corporation, Tokyo (JP)

(72) Inventors: Yoshio KAMEDA, Tokyo (JP); Keita SAKUMA, Tokyo (JP); Ryuta MATSUNO, Tokyo (JP); Masakazu HIROKAWA, Tokyo (JP)

(73) Assignee: NEC Corporation, Tokyo (JP)

(21) Appl. No.: 18/945,711

(22) Filed: Nov. 13, 2024

(30) Foreign Application Priority Data
Dec. 19, 2023 (JP) 2023-213629

(51) Int. Cl. G06F 40/58

(52) U.S. Cl. CPC G06F 40/58

(57) ABSTRACT

A prompt acquisition means acquires a prompt described in natural language which includes a designation of a prediction task and a request for information concerning a special factor which may affect the prediction task. A special factor acquisition means interprets the prompt using natural language, and acquires information concerning the special factor which may affect the prediction task designated. A model information acquisition means acquires model information concerning a model which can be used in a case of corresponding to the special factor. An output means outputs an answer including information concerning the special factor and the model information acquired.

### TECHNICAL FIELD

The present disclosure relates to prediction using a machine learning model.

### BACKGROUND ART

Various predictions have been made using machine learning models. In a case where a prediction error occurs during an operation of a model, a model designer and manager would investigate an occurrence of an event or change in a social trend which did not exist when the model was trained, and consider how to respond, but such investigation has been time-consuming and expensive. Patent Document 1 discloses a technique for predicting variation of a power demand in consideration of an influence degree of the event.

### PRECEDING TECHNICAL REFERENCES

### Patent Document

Patent Document 1: Japanese Laid-open Patent Publication No. 2018-124727

### SUMMARY

### Problem to be Solved by the Invention

It is one object of the present disclosure to propose a predictive model in consideration of special circumstances.

### Means for Solving the Problem

According to an example aspect of the present disclosure, there is provided an information processing device including:
at least one memory configured to store instructions: and
at least one processor configured to execute the instructions to:
acquire a prompt described in natural language which includes a designation of a prediction task and a request for information concerning a special factor which may affect the prediction task:
interpret the prompt using natural language, and acquire information concerning the special factor which may affect the prediction task designated;
acquire model information concerning a model which can be used in a case of corresponding to the special factor: and
output an answer including information concerning the special factor and the model information acquired.

According to another example aspect of the present disclosure, there is provided an information processing method performed by a computer, including:
acquiring a prompt described in natural language which includes a designation of a prediction task and a request for information concerning a special factor which may affect the prediction task:
interpreting the prompt using natural language, and acquiring information concerning the special factor which may affect the prediction task designated:
acquiring model information concerning a model which can be used in a case of corresponding to the special factor: and
outputting an answer including information concerning the special factor and the model information acquired.

According to a further example aspect of the present disclosure, there is provided a recording medium storing a program, the program causing a computer to perform a process including:
acquiring a prompt described in natural language which includes a designation of a prediction task and a request for information concerning a special factor which may affect the prediction task;
interpreting the prompt using natural language, and acquiring information concerning the special factor which may affect the prediction task designated:
acquiring model information concerning a model which can be used in a case of corresponding to the special factor: and
outputting an answer including information concerning the special factor and the model information acquired.

### Effect of the Invention

According to the present disclosure, it becomes possible to propose a predictive model in consideration of special circumstances.

### BRIEF DESCRIPTION OF THE DRAWINGS

FIG. 1 illustrates an overall configuration of a management system of a machine learning model in which an information processing device according to the present disclosure is applied.

FIG. 2 is a block diagram illustrating a hardware configuration of a server device.

FIG. 3 is a block diagram illustrating a hardware configuration of a terminal device.

FIG. 4 is a block diagram illustrating functional configurations of the terminal device and the server device.

FIG. 5 illustrates an example of predictive model data stored in a pre

FIG. 6 illustrates an example of explanatory variable data stored in an explanatory variable database.

FIG. 7 illustrates an example of special factor data stored in a special factor data database.

FIG. 8A, FIG. 8B, and FIG. 8C illustrate examples of a prompt input by a user and an answer to that prompt.

FIG. 9A, FIG. 9B, and FIG. 9C illustrate examples of a prompt input by a user and an answer to that prompt.

FIG. 10 is a flowchart of a predictive model proposal process.

FIG. 11 is a block diagram illustrating a functional configuration of an information processing device of a second example embodiment.

FIG. 12 is a flowchart of a process by the information processing device of the second example embodiment.

### EXAMPLE EMBODIMENTS

In the following, example embodiments will be described with reference to the accompanying drawings.

### First Example Embodiment

### [Overall Configuration]

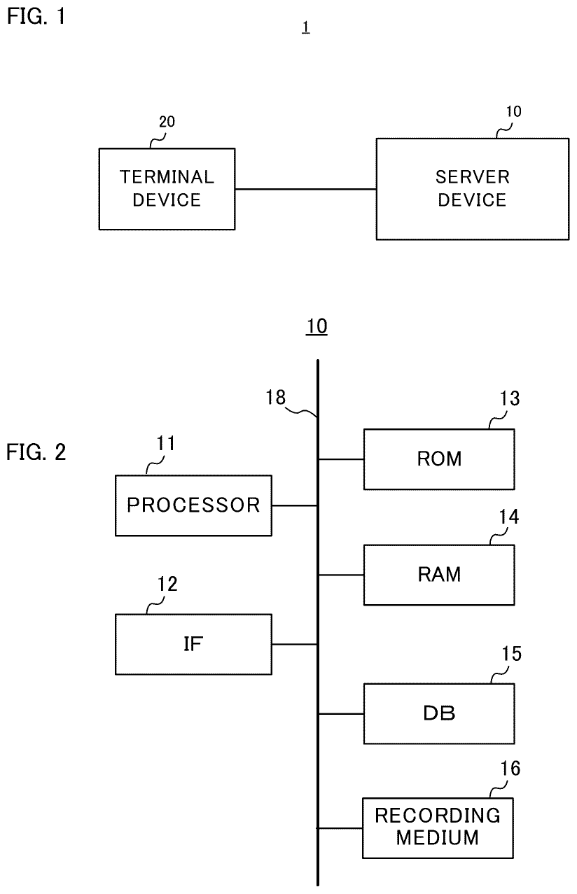

FIG. 1 illustrates an overall configuration of a management system (hereinafter, simply referred to as a “management system”) of a machine learning model to which an information processing device according to the present disclosure is applied. A manager of a machine learning model or the like (hereinafter, simply referred to as a “user”) requests information concerning a special factor which may affect prediction to a management system 1 in a case where a decrease in prediction accuracy (hereinafter, also referred to as a “prediction error”) occurs during an operation of a prediction process using the machine learning model. The management system 1 provides information concerning the special factor if there is any special factor which may affect the prediction. Moreover, in a case where there is a predictive model usable under the special factor, the management system 1 proposes that predictive model. Accordingly, it is possible for the user to respond to the prediction error by, for instance, changing the machine learning model used for the prediction when the prediction error occurs due to the special factor.

As illustrated in FIG. 1, the management system 1 includes a server device 10 and a terminal device 20. The server device 10 and the terminal device 20 can mutually communicate via a wired or wireless network.

The terminal device 20 is operated by the user who designs and manages the machine learning model. The user specifies a prediction task for the terminal device 20, and requests information concerning the special factor which may affect the prediction. Although details will be described later, the terminal device 20 includes a natural language model capable of interpreting natural language. The user inputs a prompt written in natural language into the terminal device 20. The user includes in this prompt a designation of the prediction task and a request of information concerning the special factor. Note that the “prompt” refers to an instruction statement to a generative AI (Artificial Intelligence) including the natural language model, or the like. The terminal device 20 receives the input to the prompt, and interprets the prompt using the natural language model to recognize the prediction task designated by the user and an information request of the special factor. Then, the terminal device 20 searches and acquires the special factor which may affect the designated prediction task by using the natural language model.

The server device 10 stores prediction-related information prepared in association with various tasks in a database or the like. In a case where the terminal device 20 finds a special factor which may affect the prediction task designated by the user, the terminal device 20 accesses the database of the server device 10, refers to the prediction-related information concerning the prediction task designated by the user and the special factor obtained, and acquires information concerning the predictive model usable under the special factor.

The prediction task designated by the user includes, for instance, various prediction tasks such as prediction of product demand, prediction of electric power demand, and prediction of weather. Note that in the following description, the prediction task designated by the user is assumed to be a prediction of product demand in a certain store.

The terminal device 20 acquires the information concerning the predictive model which can be used under special factor and presents the information to the user. Thus, it is possible for the user to obtain information concerning the special factor which is considered to be a cause of the prediction error and the predictive model which can be used under the special factor by performing the input by natural language.

### [Natural Language Model]

In the following, the natural language model will be described. The natural language model is a model which learns a relationship between words in a sentence, and generates a relevant string concerning a target string from the target string. By using the natural language model which learns sentences and texts of various contexts, it is possible to generate the relevant string with appropriate content concerning the target string. For instance, a case where the natural language model is used in a question and answer will be described. In this case, the natural language model accepts an input of a question “What kind of country is Japan?” as the target string, and generates “Japan is an island country in the northern hemisphere . . . ” as the answer to the question.

A learning method of the natural language model is not particularly limited, but may be a model which is trained to output at least one sentence including an input string as an example. For instance, the natural language model may be a GPT (Generative Pre-Training) which outputs a sentence containing the input string by predicting a string with a high probability of following the input string. Alternatively, the natural language model such as T5 (Text-to-Text Transfer Transformer), BERT (Bidirectional Encoder Representations from Transformers), ROBERTa (Robustly optimized BERT approach), and ELECTRA (Efficiently Learning an Encoder that Classifies Token Replacements Accurately) can be used. In the present example embodiment, a large-scale language model may be used as the natural language model. Also, the natural language model may be capable of accessing the Internet or other specialized knowledge bases to obtain information.

### [Hardware Configuration]

### (Server Unit)

FIG. 2 is a block diagram illustrating a hardware configuration of the server device 10. As illustrated in FIG. 2, the server device 10 includes a processor 11, an interface (IF) 12, a ROM (Read Only Memory) 13, a RAM (Random Access Memory) 14, a database (DB) 15, and a recording medium 16. These components are mutually connected, for instance, through a bus 18.

The processor 11 is a computer such as a CPU (Central Processing Unit), and controls the entire server device 10 by executing a program prepared in advance. Specifically, the processor 11 may be a CPU, a GPU (Graphics Processing Unit), a DSP (Digital Signal Processor), a MPU (Micro Processing Unit), an FPU (Floating Point number Processing Unit), a PPU (Physics Processing Unit), a TPU (Tensor Processing Unit), a quantum processor, a microcontroller, or a combination thereof.

Also, the processor 11 loads the program stored in a ROM 13 or the recording medium 16 to a RAM 14, and executes the processes coded in the program. The processor 11 acts as part or all of the server device 10.

The IF 12 transmits and receives data to and from an external device. Specifically, the server device 10 transmits and receives data to and from the terminal device 20 through the IF 12.

The ROM 13 stores various programs executed by the processor 11. The RAM 14 is used as a working memory during various processes performed by the processor 11. The DB 15 stores the prediction-related information for various tasks. The prediction-related information will be described later.

The recording medium 16 is a non-volatile and non-transitory recording medium such as a disc-shaped recording medium or a semiconductor memory. The recording medium 16 may be detachably formed to the server device 10. The recording medium 16 records various programs executed by the processor 11.

### (Terminal Device)

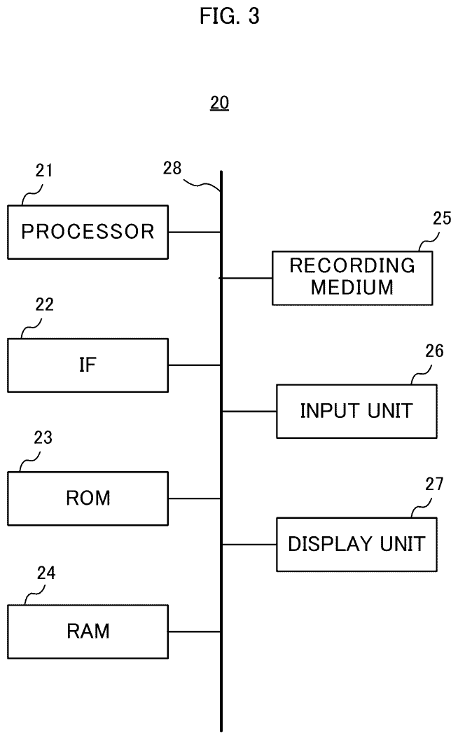

FIG. 3 is a block diagram illustrating a hardware configuration of the terminal device 20. The terminal device 20 is, for instance, a PC or a tablet terminal. As illustrated in FIG. 3, the terminal device 20 includes a processor 21, an IF 22, a ROM 23, a RAM 24, an input unit 26, and a display unit 27. These components are mutually connected, for instance, through a bus 28.

The processor 21 is a computer such as a CPU, and controls the entire terminal device 20 by executing programs prepared in advance. The processor 21 may be a GPU, FPGA, DSP, ASIC or the like.

The IF 22 transmits and receives data to and from an external device. Specifically, the terminal device 20 accesses the DB 15 of the server device 10 through the IF 22 and acquires the prediction related information.

The ROM 23 stores various programs executed by the processor 21. Also, the RAM 24 is used as a working memory during various operations performed by the processor 21.

A recording medium 25 is a non-volatile and non-transitory recording medium such as a disc-shaped recording medium or a semiconductor memory. The recording medium 25 may be detachably formed to the terminal device 20. The recording medium 25 records various programs executed by the processor 21.

The input unit 26 is, for instance, an input device such as a keyboard, a mouse, or a touch panel. The user inputs a prompt including a designation of a task and presentation request of the special factor by operating the input unit 26. The display unit 27 is a display or the like for displaying based on a control of the processor 21. An answer which the user input to the prompt is displayed on the display unit 27 and presented to the user.

### [Function Configuration]

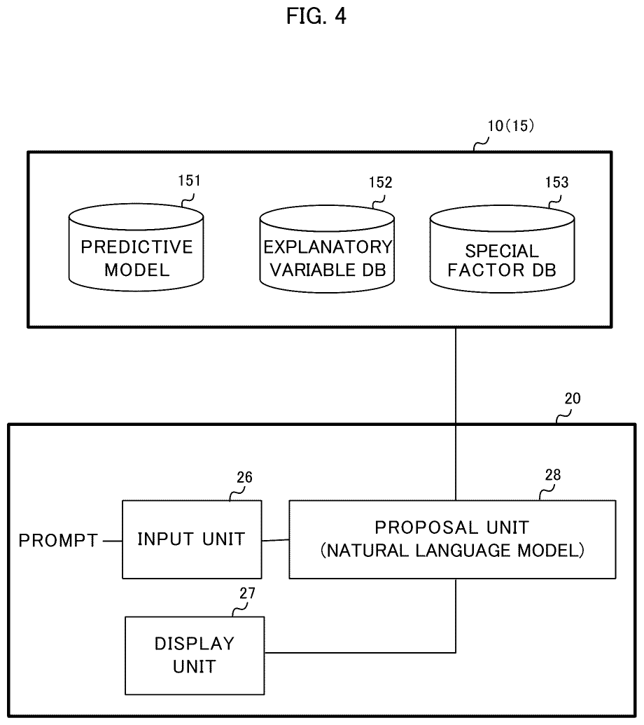

FIG. 4 is a block diagram illustrating functional configurations of the server device 10 and the terminal device 20. The server device 10 includes a predictive model DB 151, an explanatory variable DB 152, and a special factor DB 153 in the DB 15. On the other hand, the terminal device 20 includes a proposal unit 28 in addition to the input unit 26 and the display unit 27 described above.

As described above, the database 15 stores the prediction-related information. The prediction-related information includes predictive model data, explanatory variable data, and special factor data. The predictive model DB 151 stores the predictive model data, the explanatory variable DB 152 stores the explanatory variable data, and the machining method DB 153 stores the machining special factor data.

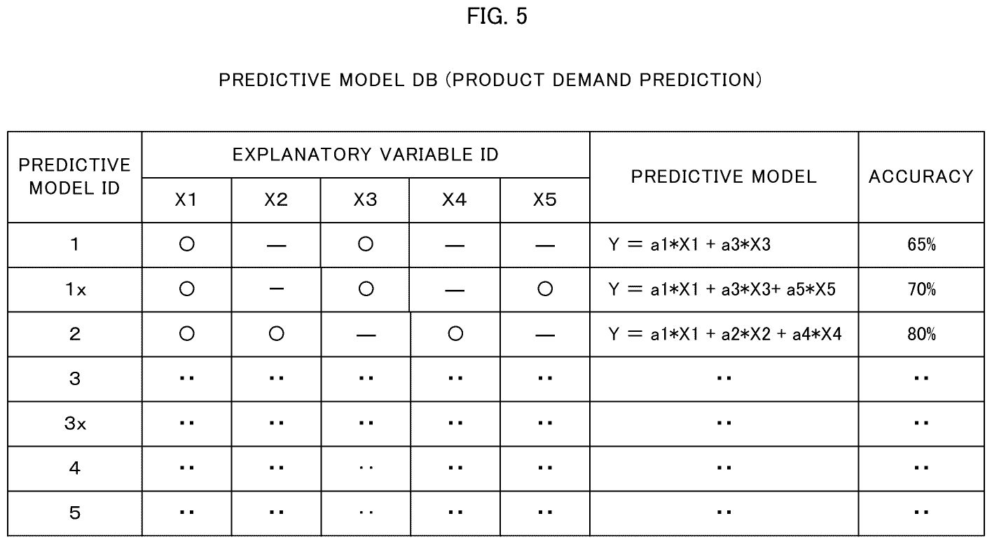

FIG. 5 illustrates an example of the predictive model DB 151 storing the predictive model data. The predictive model DB 151 stores predictive model data indicating, for each task, a predictive model corresponding to that task. In the example embodiment in FIG. 5, the predictive model DB 151 stores data for a plurality of predictive models which are used in a task of “product demand prediction”. Specifically, the predictive model data include items of “predictive model ID,” “explanatory variables.” “predictive model,” and “accuracy”. The item “predictive model ID” is identification information of the respective predictive model. The item “explanatory variables” indicate one or more variables used in each respective predictive model. The item “predictive model” indicates a mathematical expression representing each predictive model. Note that in this example, for convenience of explanation, each predictive model is illustrated by the mathematical expression, but the predictive model is not limited to that shown as the mathematical expression. The item “accuracy” indicates accuracy of the prediction by each predictive model.

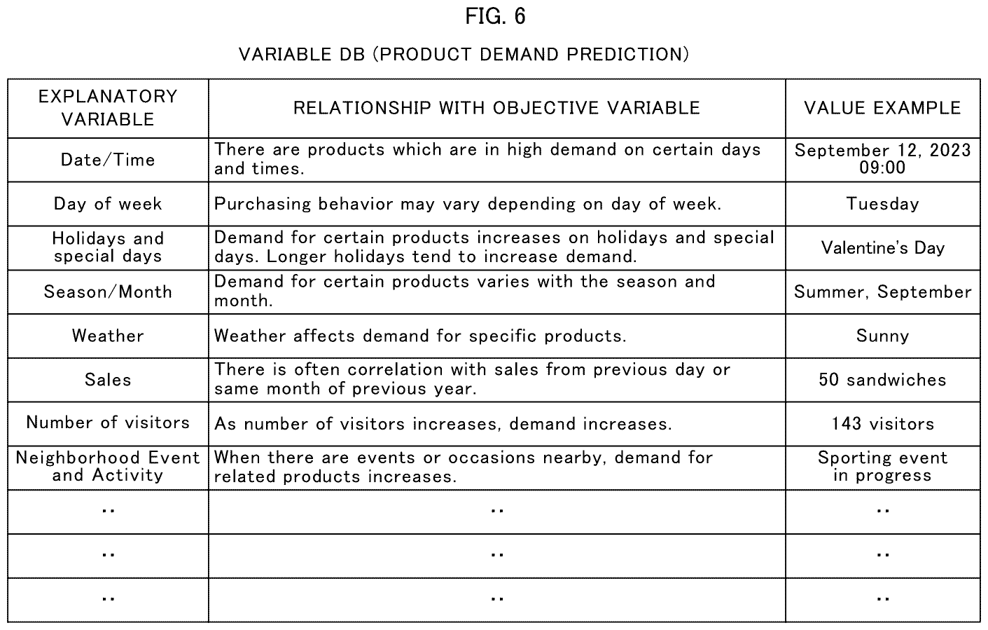

FIG. 6 illustrates an example of the explanatory variable DB 152 storing the explanatory variable data. The explanatory variable DB 152 stores, for each task, the explanatory variable data representing each explanatory variable used for the prediction corresponding to the task. In the FIG. 6, the explanatory variable DB 152 stores the explanatory variable data for each explanatory variable used for the task “product demand prediction”. Specifically, the explanatory variable data include items of “explanatory variable”, “relationship with the objective variable”, and “value example”. The item “relationship with the objective variable” is represented by information which indicates a relationship between each explanatory variable and the objective variable of the task (in this example, the product demand). The item “value example” indicates an example represented as a numerical value which each explanatory variable can take.

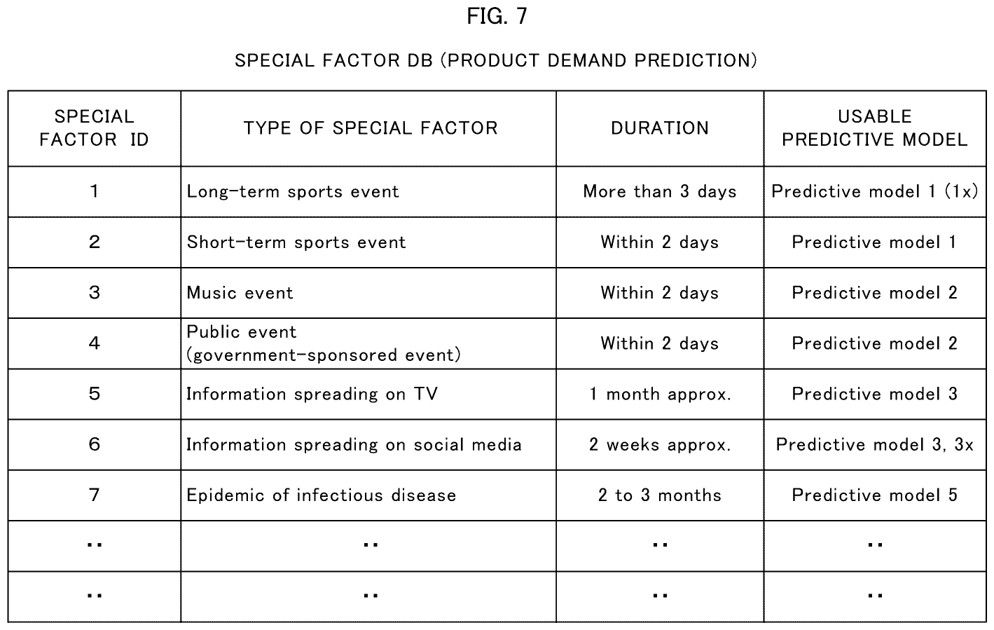

FIG. 7 illustrates an example of the special factor DB 153 storing the special factor data. The special factor DB 153 stores, for each task, the special factor data regarding the special factor which may affect the prediction corresponding to that task.

In the example illustrated in FIG. 7, the special factor DB 153 stores the special factor data which may affect the task of “product demand prediction”. Specifically, the special factor data include items of “special factor ID”, “type of special factor”, “duration”, and “usable predictive model”.

The item “special factor ID” indicates identification information of each special factor. The item “type of special factor” indicates a result from classifying each special factor based on its nature. Specifically, the item “type of special factor” includes any of various types of events. In a case where various events are held nearby a store subject for demand prediction, the demand prediction varies due to the events and product demand is affected. Therefore, various events are included in the special factors. In addition, the types of special factors include information spreading on social media, television, or the like. If a shop or a product is introduced through the social media, television, or the like, the product demand varies due to the spread of the information, and the demand prediction is affected. Therefore, spreading of information through media is included in the special factors. Moreover, infectious diseases such as coronaviruses and influenza and epidemics of such disease are possible to affect the product demand. For instance, due to epidemics of infectious diseases, the demand for preventive products such as masks and gargle solutions increases. Therefore, infectious diseases and epidemics are included in the special factors.

The item “duration” generally indicates a period during which each special factor is expected to continue. Basically, the longer the duration, the greater the variability in the product demand due to the special factor. Accordingly, the duration of each special factor is a factor which affects the demand prediction.

The “usable predictive model” indicates an example of the predictive model that can be suitably used under each special factor. In the example in FIG. 7, a predictive model 1 can be used during long-term and short-term sports events, and a predictive model 2 can be used during a music event and a public event. Note that a predictive model 1x of the long-term sports event in parentheses will be described later. One or more predictive models which can be used under each special factor are determined in advance based on one or more explanatory variables included in each predictive model and combinations thereof. For instance, although not illustrated in FIG. 7, in a case where there is an outdoor event and an indoor event as the special factors, a model including “weather” in the explanatory variables may be set as the predictive model which can be used for the outdoor event and a model not including “weather” in the explanatory variables may be set as the predictive model which can be used for the indoor event.

### [Generation of Special Factor Data]

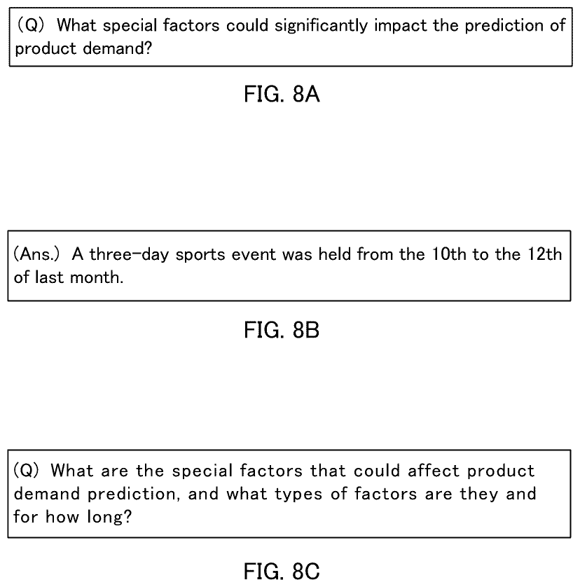

Next, a process at a time of generation of the special factor data as described above will be described. In a case where the prediction error occurs during the operation of a machine learning model, the user considers that one cause is the special factor as described above. In this case, the user inquires the terminal device 20 of a presence or absence of the special factor which may affect the prediction. Specifically, the user operates the input unit 26 to input the prompt as illustrated in FIG. 8A.

The input prompt is input to the proposal unit 28 illustrated in FIG. 4. The proposal unit 28 is formed by using the natural language model, and outputs an answer to the input prompt to the display unit 27. For instance, as illustrated in FIG. 8B, the proposal unit 28 answers that a three-day sports event was held last month. The user who reads this answer may assume that the product demand increased due to the sports event and that the prediction error may have occurred. Then, the user can collect data such as data of each explanatory variable or actual sales of the store during the period in which the sport event was actually held, and perform re-learning of the predictive model, thereby creating a predictive model suitable for use during the sports event. For instance, the user may generate the predictive model 1x suitable for use in the sports event based on the predictive model 1 used in a normal period, and register the generated predictive model 1x in the predictive model DB 151 as illustrated in FIG. 5. Moreover, it is possible for the user to register the predictive model 1x as the “usable predictive model” corresponding to the “long-term sports event” in the special factor DB 153 based on an answer message illustrated in FIG. 8B (refer to FIG. 7).

Note that in a case where the user knows that the “type of special factor” and the “duration” can be registered in the special factor DB 153, the user may input a prompt as illustrated in FIG. 8C so that the type and the duration of the special factor are included in the answer message from the proposal unit 28.

Thus, in a case where a prediction error occurs, by creating a prompt and inquiring using the created prompt to the terminal device 20, it is possible for the user to investigate whether an occurrence of the special factor is contributed to the prediction error. Then, in a case where the occurrence of the special factor is assumed to be the cause of the prediction error based on an answer from the terminal device 20, by performing such re-learning of the predictive model using data obtained during the occurrence of the special factor, it is possible to generate and register the predictive model suitably usable under the special factor. Thus, as illustrated in FIG. 7, the special factor DB 153 is formed. Although one terminal device 20 is connected to the server device 10 in the example in FIG. 1, by connecting a plurality of terminal devices 20 used by a plurality of users are connected to the server device 10 and sharing the DB 15 of the server device 10 with the plurality of users, it is possible to efficiently form and update the special factor data and the predictive model data.

[Proposal of Model under Special Factor]

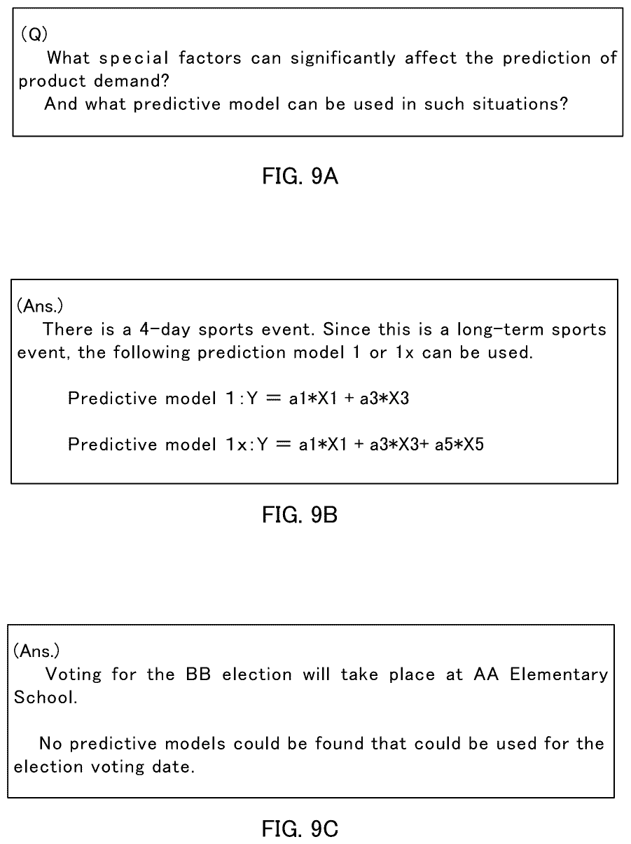

Next, an example of proposing a model which can be used under the special factor will be described. In a case where a prediction error occurs during an operation of the machine learning model, the user considers the presence or absence of the special factor as described above as one cause. In this case, the user inquires the terminal device 20 of whether or not there is the special factor which may affect the prediction, and the predictive model which can be used under the special factor. For instance, the user operates the input unit 26 to input a prompt as illustrated in FIG. 9A.

The input prompt is input to the proposal unit 28 illustrated in FIG. 4. The proposal unit 28 interprets the input prompt and generates information concerning the special factor which may affect the designated prediction task. Next, the proposal unit 28 accesses the special factor DB 153 of the server device 10 and searches for the predictive model which can be used under the special factor. In a case where the information indicating the predictive model which can be used under the special factor is in the special factor DB 153, the proposal unit 28 acquires information indicating the predictive model which can be used, for instance, the predictive model ID or the like. In addition, the proposal unit 28 acquires information of the predictive model from the predictive model DB 151 based on the acquired predictive model ID. Then, the proposal unit 28 displays the information of the special factor and the predictive model which can be used under that special factor on the display unit 27.

Now, based on the prompt illustrated in FIG. 9A, it is assumed that the proposal unit 28 acquires information of a “four-day sports event” as the special factor. The proposal unit 28 first accesses the special factor DB 153 to determine whether or not the information concerning the special factor suitable for the “four-day sports event” is registered. In FIG. 7, a “long-term sports event” with the special factor ID=1 is registered. Therefore, the proposal unit 28 determines that the “long-term sports event” with the special factor ID=1 is suitable for the “four-day sports event”. Next, the proposal unit 28 acquires “the predictive models 1 and 1x” as the predictive models that can be used in the “long-term sports event” in which the special factor ID=1, and accesses the predictive model DB 151 illustrated in FIG. 5 to acquire the information of the predictive model 1 and 1x. Then, the proposal unit 28 generates an answer message including the acquired special factor, the information of the special factor, and the information of each model which can be used under that special factor, and displays the information on the display unit 27. For instance, the proposal unit 28 generates and displays the answer message as illustrated in FIG. 9B. Thus, the user can acquire the information concerning the special factor which is considered to be a cause of the prediction error, and the information concerning each predictive model which can be used under the special factor.

Incidentally, in a case where the proposal unit 28 finds the special factor (tentatively “voting for election”) for the prompt illustrated in FIG. 9A, but information concerning that special factor has not been registered in the special factor DB 153, the proposal unit 28 cannot propose a predictive model which can be used under that special factor. In this case, the proposal unit 28 displays the answer message as illustrated in FIG. 9C, for instance. In this case, as described in the [Generation of Special Factor Data] section above, it is possible for the user to collect data such as data of each explanatory variable and sales of stores at a time the election was voted in the past, to create a predictive model which can be used for a voting day of the election by learning the predictive model, and to register the created predictive model in the predictive model DB 151 and the special factor DB 153.

In a case where a plurality of special factors are found for the prompt input by the user, the proposal unit 28 acquires information of the predictive model which can be used from the special factor DB 153 for each special factor and displays the information on the display unit 27. Accordingly, it is possible for the user to consider the plurality of special factors as causes of prediction errors and consider the use of a predictive model as appropriate.

As described above, in a case where the prediction error occurs, it is possible for the user to acquire information concerning the presence or absence of the special factor which may affect the prediction, and a proposal for the predictive model which can be used in a case where the special factor exists, by describing the prompt in natural language and inputting the prompt to the terminal device 20.

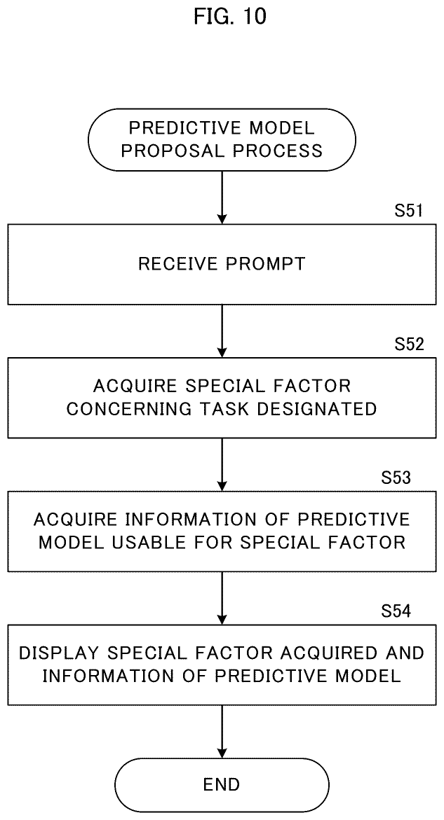

FIG. 10 illustrates a flowchart of a predictive model proposal process. The predictive model proposal process is a process to propose a predictive model which can be used under a certain special factor as described above. This process is realized by the processor 21 illustrated in FIG. 3 which executes a corresponding program prepared in advance and operates as a corresponding element illustrated in FIG. 4.

First, if the user inputs a prompt, the proposal unit 28 receives the prompt which has been input (step S51). Next, the proposal unit 28 searches for a special factor related to the task designated in the prompt and acquires the special factor (step S52). Next, the proposal unit 28 accesses the special factor DB 153 and the predictive model DB 151 of the server device 10 and acquires information of the predictive model which can be used in the acquired special factor (step S53). Next, the proposal unit 28 displays the special factor and the information of the predictive model which can be used in the special factor on the display unit 27 (step S54). Accordingly, the predictive model proposal process is terminated.

### [Modifications]

Next, a modification of the above example embodiment will be described. The following modifications may be combined as appropriate.

### (Modification 1)

In the example embodiment described above, the proposal unit 28 including the natural language model is provided in the terminal device 20. Instead, one proposal unit may be provided in the server device 10, and the proposal unit may provide information of a special factor or information of a predictive model which can be used to the user. In this case, the terminal device 20 transmits a prompt input by the user to the server device 10. In the server device 10, first, the proposal unit acquires the information of the special factor based on the prompt. Next, the proposal unit accesses the DB 15 to refer to the special factor data and the predictive model data, and acquires the information of the predictive model which can be used in the special factor. Then, the server device 10 transmits the acquired information of the special factor and the acquired information of the predictive model to the terminal device 20. The terminal device 20 may display the received information as an answer message.

### (Modification 2)

The predictive model DB 151, the explanatory variable DB 152, and the special factor DB 153 stored in the DB 15 of the server device 10 may be data stored in natural language. In this case, the proposal unit proposes a usable predictive model using the special factor data and the predictive model data described in natural language.

### Second Example Embodiment

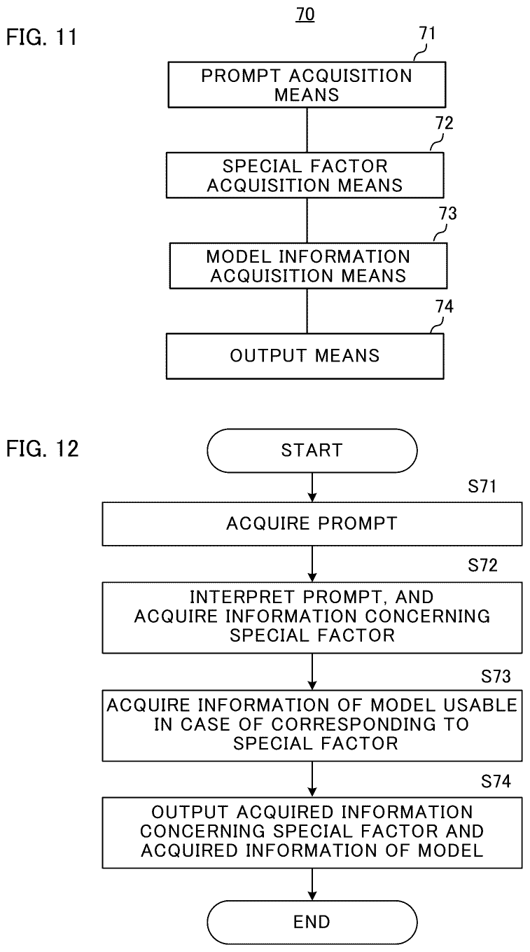

FIG. 11 is a block diagram illustrating a functional configuration of an information processing device according to a second example embodiment. An information processing device 70 includes a prompt acquisition means 71, a special factor acquisition means 72, a model information acquisition means 73, and an output means 74.

FIG. 12 is a flowchart of a process performed by the information processing device according to the second example embodiment. The prompt acquisition means 71 is described in natural language, and acquires a prompt including a request for information concerning a designation of a prediction task and a special factor which may affect the prediction task (step S71). The special factor acquisition means 72 interprets the prompt using a language model and acquires information concerning the special factor which may affect the designated prediction task (step S72). The model information acquisition means 73 acquires model information regarding a model which can be used in a case of corresponding to the special factor (step S73). The output means 74 outputs an answer including the information concerning the special factor and the acquired model information (step S74).

According to the information processing device 70 of the second example embodiment, it becomes possible to propose the predictive model in consideration of occurrence of the special factor.

A part or all of the example embodiments described above may also be described as the following supplementary notes, but not limited thereto.

(Supplementary note 1)
1. An information processing device comprising:
a prompt acquisition means configured to acquire a prompt described in natural language which includes a designation of a prediction task and a request for information concerning a special factor which may affect the prediction task:
a special factor acquisition means configured to interpret the prompt using natural language, and acquire information concerning the special factor which may affect the prediction task designated:
a model information acquisition means configured to acquire model information concerning a model which can be used in a case of corresponding to the special factor: and
an output means configured to output an answer including information concerning the special factor and the model information acquired.
   (Supplementary note 2)
2. The information processing device according to supplementary note 1, wherein the model information acquisition means acquires the model information from a storage unit which stores, for each special factor, special factor data indicating a relationship between the special factor and the model which can be used in the case of corresponding to the special factor.
   (Supplementary note 3)
3. The information processing device according to supplementary note 2, wherein
the special factor data are described in natural language: and
the model information acquisition means interprets information concerning the special factor, and acquires the model information by referring to the special factor data.
   (Supplementary note 4)
4. The information processing device according to supplementary note 3, wherein
the special factor data include a type of the special factor; and
the model information acquisition means acquires the model information based on the type of the special factor.
   (Supplementary note 5)
5. The information processing device according to supplementary note 4, wherein
the prompt includes a request of information concerning a type of the special factor; and
the answer includes the type of the special factor.
   (Supplementary note 6)
6. The information processing device according to supplementary note 3, wherein
the special factor data include duration of the special factor; and
the model information acquisition means acquires the model information based on the duration of the special factor.
   (Supplementary note 7)
7. The information processing device according to supplementary note 6, wherein
the prompt includes a request of information concerning the duration of the special factor: and
the answer includes the duration of the special factor.
   (Supplementary note 8)
8. The information processing device according to supplementary note 1, wherein the model information acquisition means outputs a message indicating that no model is available if no model is available to use in the case of corresponding to the special factor.
   (Supplementary note 9)

9. An information processing method performed by a computer, comprising:
acquiring a prompt described in natural language which includes a designation of a prediction task and a request for information concerning a special factor which may affect the prediction task:
interpreting the prompt using natural language, and acquiring information concerning the special factor which may affect the prediction task designated:
acquiring model information concerning a model which can be used in a case of corresponding to the special factor: and
outputting an answer including information concerning the special factor and the model information acquired.
   (Supplementary note 10)
10. A program causing a computer to execute processing of:
acquiring a prompt described in natural language which includes a designation of a prediction task and a request for information concerning a special factor which may affect the prediction task:
interpreting the prompt using natural language, and acquiring information concerning the special factor which may affect the prediction task designated:
acquiring model information concerning a model which can be used in a case of corresponding to the special factor; and
outputting an answer including information concerning the special factor and the model information acquired.

While the disclosure has been described with reference to the example embodiments and examples, the disclosure is not limited to the above example embodiments and examples. It will be understood by those of ordinary skill in the art that various changes in form and details may be made therein without departing from the spirit and scope of the present disclosure as defined by the claims.

### DESCRIPTION OF SYMBOLS

10 Server device
20 Terminal device
21 Processor
26 Input unit
27 Display unit
28 Proposal unit
15 Database (DB)
151 Predictive model DB
152 Explanatory variable DB
153 Special factor DB

1. An information processing device comprising:
at least one memory configured to store instructions; and
at least one processor configured to execute the instructions to:
acquire a prompt described in natural language which includes a designation of a prediction task and a request for information concerning a special factor which may affect the prediction task;
interpret the prompt using natural language, and acquire information concerning the special factor which may affect the prediction task designated;
acquire model information concerning a model which can be used in a case of corresponding to the special factor; and
output an answer including information concerning the special factor and the model information acquired.

2. The information processing device according to claim 1, wherein the processor acquires the model information from a storage unit which stores, for each special factor, special factor data indicating a relationship between the special factor and the model which can be used in the case of corresponding to the special factor.

3. The information processing device according to claim 2, wherein
the special factor data are described in natural language; and
the processor interprets information concerning the special factor, and acquires the model information by referring to the special factor data.

4. The information processing device according to claim 3, wherein
the special factor data include a type of the special factor; and
the processor acquires the model information based on the type of the special factor.

5. The information processing device according to claim 4, wherein
the prompt includes a request of information concerning a type of the special factor; and
the answer includes the type of the special factor.

6. The information processing device according to claim 3, wherein
the special factor data include duration of the special factor; and
the processor acquires the model information based on the duration of the special factor.

7. The information processing device according to claim 6, wherein
the prompt includes a request of information concerning the duration of the special factor; and
the answer includes the duration of the special factor.

8. The information processing device according to claim 1, wherein the processor outputs a message indicating that no model is available if no model is available to use in the case of corresponding to the special factor.

9. An information processing method performed by a computer, comprising:
acquiring a prompt described in natural language which includes a designation of a prediction task and a request for information concerning a special factor which may affect the prediction task;
interpreting the prompt using natural language, and acquiring information concerning the special factor which may affect the prediction task designated;
acquiring model information concerning a model which can be used in a case of corresponding to the special factor; and
outputting an answer including information concerning the special factor and the model information acquired.

10. A non-transitory computer-readable recording medium storing a program causing a computer to execute processing of:
acquiring a prompt described in natural language which includes a designation of a prediction task and a request for information concerning a special factor which may affect the prediction task;
interpreting the prompt using natural language, and acquiring information concerning the special factor which may affect the prediction task designated;
acquiring model information concerning a model which can be used in a case of corresponding to the special factor; and
outputting an answer including information concerning the special factor and the model information acquired.
